(19) United States
(12) Patent Application Publication
(10) Pub. No.: US 2018/0058116 A1
(43) Pub. Date: Mar. 1, 2018

(54) LOCKING DEVICE FOR A VEHICLE DOOR, AND METHOD

(71) Applicant: Magna BÖCO GmbH, Wuppertal (DE)

(72) Inventors: Bernardo Erices, Bergisch Gladbach (DE); Konstantin Krieger, Leverkusen (DE); Wolfgang Millahn, Hilden (DE)

(21) Appl. No.: 15/691,126

(22) Filed: Aug. 30, 2017

(30) Foreign Application Priority Data
Aug. 31, 2016 (DE) 102016010467.8

(51) Int. Cl. E05B 85/26; E05B 85/24; E05B 83/18

(52) U.S. Cl. CPC E05B 85/26; E05Y 2900/546; E05B 83/18; E05B 85/243

(57) ABSTRACT

A locking device for a vehicle door comprising a rotary catch which can be arrested by a pawl and which serves for trapping a closing element when the vehicle door is closed. The pawl has a pawl blocking surface and the rotary catch has a counterpart catch blocking surface which can be placed in engagement with the pawl blocking surface. A special feature resides in that the pawl or the rotary catch has a tracking lever by means of which the pawl blocking surface or the counterpart catch blocking surface can be caused to perform a tracking movement. During this tracking movement, the rotary catch is pivoted over a defined pivot angle (α) in an opening direction (Ö) without the pawl blocking surface and the counterpart catch blocking surface moving out of engagement in the process, thereby reducing the seal loads prior to release of the rotary catch.

### CROSS-REFERENCE TO RELATED APPLICATIONS

This application claims the benefit and priority of German Application No. 102016010467.8, filed Aug. 31, 2016. The entire disclosure of the above application is incorporated herein by reference.

### FIELD

The present disclosure relates generally to locking devices for a vehicle door. More particularly, the present invention relates to such a locking device for a motor vehicle tailgate flap having a rotary catch, a pawl for selectively immobilizing the rotary catch, and a tracking lever providing a tracking movement between blocking surfaces formed on the rotary catch and the pawl during initial rotation of the rotary catch toward an open position.

### BACKGROUND

This section provides background information related to locking devices which is not necessarily prior art to the present disclosure.

Locking devices for a vehicle door, such as a motor vehicle tailgate flap, typically comprise a pivotable rotary catch and a pawl which can selectively immobilize the rotary catch. In particular, such locking devices are used for vehicle doors or flap which are surrounded by encircling seals, or which are intended to close a vehicle opening with a corresponding seal arranged at the opening. Specifically, from the area of motor vehicle tailgate flaps, the problem is known that, during an opening of the locking device an undesired noise is generated. This results, for example, in a relatively loud bang or click or the like. Of significance for such noise is the relatively high exertion of force on the pawl and the rotary catch by the seal element. Here, it is assumed that the seal element is compressed to a maximum extent when the locking device is in the closed position and the seal element is relaxed to a maximum extent when a vehicle door or flap is open.

Since, at the moment in which the pawl releases the rotary catch for the purposes of performing an opening process, the seal element is typically still compressed to a maximum extent, the seal element also exerts a maximum force on the rotary catch and the pawl at this moment (at any rate indirectly via the flap and a corresponding closing element). Owing to the large seal force that acts in particular on the rotary catch, the pawl and the rotary catch, which are typically both composed of metal, generate a corresponding noise during the unlocking action, which in the prior art occurs relatively abruptly. Further considerations are based on the fact that additional elements may also be jointly responsible for said generation of noise, for example a certain degree of play in the rotary catch spindle or the like.

Further areas of applicability will become apparent from the description provided herein. The description and specific examples in this summary are intended for purposes of illustration only and are not intended to limit the scope of the present disclosure.

### SUMMARY

This section provides a general summary of the present invention and is not intended to be interpreted as a comprehensive and exhaustive listing of its full scope or all of its features and embodiments.

It is therefore an object of the present invention to provide a locking mechanism which counteracts a corresponding generation of noise, or to eliminate such generation of noise entirely.

The invention achieves the underlying object, in accordance with a first aspect, by means of the features of a locking device of claim 1, and is characterized in that the pawl or the rotary catch is assigned a tracking lever by means of which a blocking surface or a counterpart blocking surface can be caused to perform a tracking movement such that the rotary catch is pivotable over a defined pivot angle in an opening direction without the blocking surface and the counterpart blocking surface moving out of engagement in the process.

In other words, the generation of noise is suppressed by virtue of the contact region between the pawl and the rotary catch, which is commonly utilized for the arresting of the rotary catch, being at any rate initially displaced or moved concomitantly during the opening process of the locking device, without the pawl and the rotary catch passing out of contact or out of engagement in the process. For this purpose, the blocking surface is formed on the pawl tangentially with respect to the pawl spindle.

In this context, the locking device remains closed because the contact region between the pawl and the rotary catch is displaced. Here, such displacement occurs in a relaxation direction of the seal element, such that the seal element, at any rate during a first part of the opening process, can (partially) relax, and a force acting on the rotary catch (via the vehicle door and the closing element) is at any rate partially dissipated in the process.

When the locking device is closed, the blocking surface and counterpart blocking surface which are in engagement with one another are oriented preferably tangentially with respect to a pawl spindle which facilitates a tracking movement.

In a second part of the opening movement, the pawl and the rotary catch are then moved actually out of engagement. Owing to the fact that the contact region has however already been caused to perform a tracking movement, and that the rotary catch has already rotated in an opening direction through a defined angle (and thus the acting force—as described above—no longer acts on the rotary catch and on the contact region), a very much softer separation of the pawl and the rotary catch, or of the blocking surface of the pawl and the counterpart blocking surface of the rotary catch, occurs. This leads to a considerable minimization of noise.

During the first part of the opening movement, the rotary catch may pivot through the defined angle, wherein, during the entire pivoting movement, the rotary catch remains held or arrested by the pawl. The locking device thus remains closed even when the defined pivot angle is reached. A closing element cannot escape from the jaw of the rotary catch. In particular, the blocking surface and counterpart blocking surface remain in engagement and the contact region between the pawl and the rotary catch is typically maintained (which advantageously also means that the pawl does not come into contact with some other region of the rotary catch, such as for example the pre-latching portion or the like, but rather the blocking surface and counterpart blocking surface remain in contact in a substantially unchanged manner).

Proceeding from a position after the defined pivot angle of the rotary catch has been reached, a conventional transfer of the pawl into its release position can occur, such that the rotary catch can then pivot from the abovementioned blocking position (also referred to here as “tracked blocking position”) into an open position. The closing element is then released.

According to the invention, the tracking movement of the blocking surface and/or the counterpart blocking surface is realized in this case by a tracking lever. The tracking lever can ensure, by means of a pivoting process, that the contact between the blocking surface and the counterpart blocking surface is maintained, even during a transfer or tracking movement of the rotary catch along the defined pivot angle.

The tracking lever may, for example, be designed as a single-armed lever which is fixed at one end thereof to a vehicle body or mounting plate and which, by means of its other end, ensures the described tracking movement. For this purpose, it is possible for the pawl to be arranged on the other end of the tracking lever, or else the tracking lever may be assigned to the rotary catch and provide, for example, the counterpart blocking surface.

In both cases, owing to a movement, in particular a pivoting movement of the tracking lever, a tracking movement of the contact region is made possible. As already described, for this purpose, the tracking lever is advantageously pivoted. It is however basically also encompassed by the invention for a corresponding lever to be displaced in some other manner, for example in a linear manner, or the like. What is essential here is the tracking effect between a blocking surface and a counterpart blocking surface. The tracking movement is typically performed in an opening direction, that is to say in a direction in which the closing element seeks to move, for a movement of the vehicle door away from the vehicle body. The pawl and the rotary catch or the blocking surface and the counterpart blocking surface can then pass out of engagement for an opening of the vehicle door, for example by means of a conventional pivoting movement of the pawl away from the rotary catch.

The tracking lever advantageously engages on the pawl or on the rotary catch, which means substantially that the tracking lever acts on the pawl or on the rotary catch, directly or else indirectly, with the aid of interposed lever elements or the like. The tracking lever may however also merely be arranged on the rotary lever or on the pawl without engaging directly thereon, wherein, in any case, the tracking lever (actively or passively) has the effect, by means of a movement (pivoting movement), that the rotary catch passes through the defined pivot angle.

The tracking lever ensures a displacement either of the blocking surface or of the counterpart blocking surface. If the blocking surface is to be displaced for the tracking movement, the tracking lever advantageously acts on the pawl. If the counterpart blocking surface is to be displaced, the tracking lever may be arranged on the rotary catch. At any rate, the corresponding contact between the blocking surface and the counterpart blocking surface can be caused to perform a tracking movement or displacement, which occurs when the rotary catch is closed (even though the rotary catch is passing through the pivot angle). The closing element is caught by the rotary catch. Here, the closing element may for example be arranged in the insertion slot of a mounting plate on which the rotary catch is arranged.

The closing element may typically be a limb, for example the central, middle limb of a striker or a closing bolt or a similar element. This is typically arranged on the vehicle body, whereas the rotary catch and the pawl of the locking device are fastened to the vehicle door. This arrangement may however also be reversed. The vehicle door is typically a motor vehicle tailgate flap, in the case of which a surrounding seal is very often provided (and/or often of particularly thick design) owing to a desired leak-tightness of the luggage compartment.

The invention may however also be used in the case of any other vehicle door, such as for example a front flap or a motor vehicle side door or the like. In this context, in the present patent application, the expression “vehicle door” is to be understood as encompassing all doors or flaps on or in a vehicle or motor vehicle which require locking. Here, the vehicle doors or flaps, in their closed position, commonly cover an opening in the vehicle body, which is furthermore typically often surrounded by a fully encircling seal.

In the context of the present patent application, the locking device according to the invention is in part also referred to as lock.

In a particularly advantageous embodiment of the invention, the pawl spindle can be displaced by the tracking lever. This may lead to a tracking movement of the blocking surface in a particularly simple manner, such that the counterpart blocking surface can then, together with the rotary catch, also pivot to a certain extent, specifically exactly through the defined pivot angle.

In the context of the present patent application, the expression “tracking” thus does not imperatively mean that one element (such as the blocking surface) is guided behind some other element, but rather means that a type of readjustment is performed in order to suppress a noise. The tracking movement serves for the lowering of the force of the seal. The readjustment is thus performed into a position in which an encircling seal or a seal which interacts with the vehicle door is at least partially relaxed. The tracking thus typically takes place in a relaxation direction of the seal.

The pawl spindle is particularly advantageously arranged on the tracking lever. In this way, the pawl can be adjusted directly by the tracking lever without the need for additional levers or gearing elements or the like. The tracking lever may in this case be formed for example as a single-armed lever, on one end of which its own pivot spindle is arranged and on the other end of which the pivot spindle of the pawl is provided.

In a particularly advantageous embodiment of the invention, the pawl is assigned a guide. The pawl may make contact with the guide by means of a contact element, for example a guide bolt or the like. The guide bolt or the contact element may, for this purpose, be attached directly to the pawl. The guide is advantageously a web or a similar unilateral guide. It is however alternatively also basically possible for an elongated hole, a guide slot or the like to be provided as a guide, into which the guide bolt engages. To allow the contact element to be spaced apart from a guide surface, such a guide slot or elongated hole should in this case however be designed to be slightly wider than the guide bolt or the contact element.

The pawl may be supported, in particular via the guide bolt, on the guide (during an opening process of the vehicle door or of the locking device). In this context, it is for example possible for a guide bolt which is arranged on the pawl to act on a guide surface of the guide.

In a particularly advantageous embodiment of the invention, the pawl may, during a closing process of the vehicle door (or of the locking device), assume a spacing from the guide. For example, the guide bolt may be spaced apart from the guide or from the guide surface. This permits particularly flexible functionality of the device as a whole. In this context, the pawl (or the guide bolt arranged thereon or the contact element arranged thereon) may also be used for other purposes, such as for example assisting the reversal of an anti-rattling system or the like.

The guide may in particular be divided into two parts. If it is for example a web-like guide (or else a guide formed in the manner of a guide slot), the guide may for this purpose have for example two sections. It is advantageously possible for both sections to be of substantially straight form. A bend point may then be situated between said two straight sections. In this way, the pawl is guided in an advantageous manner, and it is possible in this way for the opening process of the locking device as a whole to be divided into two parts. Accordingly, in a first section of the opening process, the pawl can be held in engagement with the rotary catch, and in a second section of the opening process (in particular by means of a change of the displacement direction of the pawl or the blocking surface), a transfer of the pawl into the release position can occur (by means of the bend point).

In a particularly advantageous embodiment of the invention, the pawl is transferred into its release position by the tracking lever. It is thus possible for the tracking lever firstly to ensure that the blocking surface of the pawl is caused to perform a tracking movement, and secondly that the pawl is transferred into its release position in which the blocking surface releases the counterpart blocking surface of the rotary catch. In this context, the tracking lever thus advantageously has a dual function.

According to the invention, the locking device is advantageously provided in the case of a vehicle door which is assigned a seal element which is compressed when the vehicle door is in a closed position and which fully relaxes over an expansion travel A when the vehicle door moves into an open position. Such a seal may for example be arranged in fully encircling fashion around an opening which is to be closed by the vehicle door in the present case. During a closing process of this type, the seal is then generally compressed in order to realize leak-tightness of the opening region.

Here, it is advantageously provided that the tracking lever causes the blocking surface or the counterpart blocking surface to perform a tracking movement which is smaller than the abovementioned expansion travel of the seal element. Since a corresponding expansion travel in the case of a seal is typically between 5 and 10 mm in length, the tracking travel described above may for example be 3 to 5 mm in length. In any case, in the first section, the seal is decompressed or at any rate partially relaxed, and thus the forces exerted by the seal on the rotary catch can be lowered or minimized.

In an advantageous embodiment of the invention, the seal element is not yet fully relaxed when the rotary catch reaches the defined pivot angle. In other words, the door can be referred to as still being sealed, or as still being closed, as soon as the rotary catch has pivoted beyond the defined pivot angle. Proceeding from this defined pivot angle, the rotary catch can however typically be pivoted onward in virtually continuous fashion, wherein the rotary catch is released from the pawl.

In a particularly advantageous refinement of the invention, the tracking lever is preloaded into its initial position. This may be realized for example by means of a spring. The tracking lever is duly typically displaced out of its starting or initial position by motor action, counter to the preload, for the purposes of activating an opening process. A return into the starting position may however then be realized specifically by means of the preload. For example, a spring may be mounted coaxially with the tracking lever and then fixed at the protruding end to the vehicle body.

For this purpose, it is then advantageously the case that the drive for transferring the tracking lever out of its starting position is not of self-locking design, in order that the spring can perform a subsequent return movement into the starting position. For this purpose, the drive may for example have a freewheel or the like. Since the pawl is arranged on the tracking lever, a return of the tracking lever may however also be performed theoretically by means of a preloaded pawl. In this case, too, the tracking lever is however regarded as being preloaded.

It may be very particularly advantageous if the pawl and/or the tracking lever interact with an anti-rattling system for acting on the closing element. Here, the return movement of the tracking lever (and thus also of the pawl) into the starting position or initial position can advantageously lead to the reversal of at least a part of the anti-rattling system, for example a wedge lever or stop lever of the anti-rattling system.

A lever of this type is typically provided in the anti-rattling system in order to prevent the action lever itself from performing a backward pivoting movement. On the other hand, the action lever must self-evidently be capable of returning into its starting position during the later closure of the locking device as a whole. For this purpose, the wedge lever or stop lever must generally be deflected. This may typically be realized with the aid of the tracking lever and/or the pawl. The pawl and/or the tracking lever may however then subsequently also be turned out of the path of the wedge lever or stop lever again. For this purpose, the pawl or a guide bolt arranged thereon may for example be spaced apart from a guide and thus situated in the travel of the wedge lever or of the stop lever in order that the action lever can engage.

As soon as the locking device is then fully locked again, the pawl has been returned into its starting position, in which the action bolt then bears against the guide and has been moved out of the path of the wedge lever or stop lever.

According to a further aspect of the invention, the invention solves the stated problem by means of the features of claim 10, in particular by means of those of the characterizing part, and is accordingly characterized in that the spindle of the pawl is arranged so as to be displaceable relative to the rotary catch, in particular relative to the spindle thereof. In other words, the concept of this aspect of the invention consists in designing a pawl to be displaceable as a whole. In this way, a tracking movement of a contact region between the pawl and the rotary catch is made possible in a particularly advantageous manner. According to the invention, the pawl is in this case displaced relative to the rotary catch, specifically in its entirety (and is not merely pivoted).

For example, the spindle of the pawl can thus be displaced relative to the (generally static) spindle of the rotary catch. The axis of the rotary catch is in this case typically fixed to a housing or mounting plate, at any rate to the vehicle body (or to the door in the case of a fastening there).

With regard to further advantages of this aspect of the invention, reference is made to the above statements relating to the main claim, which are virtually entirely transferable to this aspect of the invention.

According to a further aspect of the invention, the object on which the invention is based is achieved by means of a method according to claim 11. Accordingly, for the achievement of the object according to the invention, the following steps in particular are provided:
activating a tracking lever assigned to the pawl or rotary catch; and
causing the blocking surface or the counterpart blocking surface to perform a tracking movement such that the rotary catch pivots over a defined pivot angle in an opening direction without the blocking surface and the counterpart blocking surface moving out of engagement in the process.

The locking device according to the invention which is mentioned in claim 11 may be in particular a locking device according to one of the preceding claims 1 to 10. It is advantageously self-evidently also possible for further method steps to be provided, such as for example a subsequent pivoting-up of the pawl into a release position, which is effected in particular by the same drive as the tracking movement of the blocking surface.

All of the advantages and embodiments described in conjunction with claims 1 to 10 may accordingly self-evidently also be transferred to method claim 11. For example, in the method according to the invention, it is advantageously provided that the spindle of the pawl is displaced by the tracking lever, that the opening process is divided into two parts, for example by means of a guide which may furthermore advantageously have a bend point, that the seal element is at any rate partially relaxed as soon as the process of the disengagement of blocking surface and counterpart blocking surface takes place etc.

Merely for the sake of clarity, not all of the advantages and advantageous embodiments that have already been discussed in conjunction with one of the device claims will be repeated in conjunction with method claim 11. Further advantages and refinements of the invention emerge from the subclaims that have not been cited and from the following description of the figures.

### DRAWINGS

The drawings described herein are for illustrative purposes only of selected example embodiments and are not intended to limit the scope of the present invention.

FIG. 1 shows a highly schematic, sectional view of a first exemplary embodiment of a locking device according to the invention that is operable for trapping a closing element, illustrated by dashed lines, in a closed position with a pawl and a rotary catch in engagement, and with a tracking lever situated in an initial position, with certain structural elements being omitted;

FIG. 2 shows the locking device of FIG. 1 in a corresponding view following actuation of the tracking lever, and FIG. 2A shows an enlarged diagrammatic illustration of blocking surface and counterpart blocking surface;

FIG. 3 shows the locking device as per the preceding views in a corresponding view with the tracking lever situated in an end position and with the rotary catch released to its open position;

FIG. 4 shows the locking device as per the preceding views in a corresponding view with the tracking lever having been pivoted back but with the rotary catch still located in its open position;

FIG. 5 shows the locking device as per the preceding views in a corresponding view with the rotary catch having been pivoted back to its closed position, with the pawl engaged into a pre-latching portion and with a pull-closed lever in engagement;

FIG. 6 shows the locking device of FIG. 5 in the case of the rotary catch having been pulled to a fully closed position;

FIG. 7 shows the locking device of FIG. 1 with an additionally illustrated worm-gear drive system and anti-rattling system;

FIG. 8 shows the locking device of FIG. 7 with the worm-gear drive system omitted and with an alternative embodiment of an anti-rattling system;

FIG. 9 shows the locking device of FIG. 1 with a snow-load lever additionally illustrated;

FIG. 10 shows, in an even more schematic, lateral, sectional illustration, a second exemplary embodiment of a locking device according to the invention with a tracking lever arranged on the rotary catch;

FIG. 11 shows a highly schematic illustration of a tailgate flap and of a corresponding tailgate opening with an encircling seal, in the case of which the locking device according to the invention is used, but with the closing element arranged on the flap, and

FIG. 12 shows a highly schematic, diagrammatic illustration, approximately in the manner of a section as per the view arrow XII in FIG. 11, through the seal illustrated there in a compressed position (with closed flap) and in a position fully relieved of load.

In the following figure description, identical or similar parts are possibly denoted by identical reference designations, in part with the addition of lowercase alphabetic characters or apostrophes. In the patent claims that follow the figure description, the reference designations used in the figures and in the figure description are thus, for the sake of simplicity, possibly used (in part) without apostrophes or lowercase alphabetic characters, if the corresponding subjects are similar.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

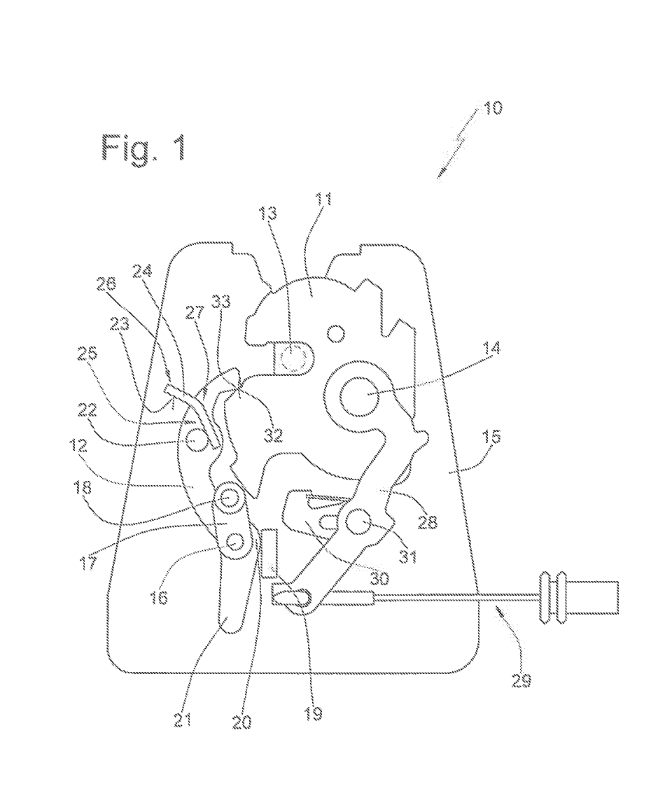

FIG. 1 shows, in a highly schematic illustration, a first exemplary embodiment of a locking device 10 according to the present invention having a rotary catch 11 and a pawl 12 which is operable to selectively arrest the rotary catch 11. The rotary catch 11 serves for trapping a closing element 13 illustrated merely by dashed lines (which closing element 13 is in part omitted for the sake of simplicity in the following figures). The closing element 13 may for example be the transverse limb of a striker or the like.

The rotary catch 11 is furthermore fixed by means of its pivot spindle 14 to a housing or to a mounting plate 15. The mounting plate 15 is in this case typically assigned to the vehicle door or flap, whereas the closing element 13 is mounted on the vehicle body (wherein this could fundamentally also be reversed). The rotary catch 11 is illustrated in FIG. 1 in its closed position or completely closed position (wherein a possible overtravel is disregarded in the figures). In this position as per FIG. 1, the rotary catch 11 is firmly arrested by the pawl 12. A special feature now resides in the fact that a pivot spindle 16 of the pawl 12 is not fixed to a housing or mounting plate, as in the case of the spindle 14 of the rotary catch 11, but rather is arranged or mounted on or fastened to a tracking lever 17.

The tracking lever 17 is fastened by means of a pivot spindle 18 to the mounting plate 15 and is pivotable about the spindle 18. FIG. 1 shows the initial or starting position of the tracking lever 17 which, with regard to FIGS. 1 to 9, is preloaded counterclockwise in a manner to be described in more detail further below. The initial position of the tracking lever 17 illustrated in FIG. 1 is in this case defined in particular by a stop 19 which is fixed to a housing or mounting plate 15 or to the vehicle body and which can interact with, and be contacted by, a knee 20 of the pawl 12.

The pawl 12 furthermore has, at the lower lever end, an engagement projection 21 which can be acted on manually by a vehicle user for the purposes of emergency unlocking of the locking device 10 (for example with the aid of a Bowden cable (not illustrated) or by purely mechanical contact with the aid of a screwdriver or the like). The user would pivot the pawl 12 about its pivot spindle 16, that is to say counterclockwise with regard to the figures, in order to hereby release the rotary catch 11. As described, this is however merely a manual assistance means. Provision is however primarily made for the opening process of the locking device 10 to be performed automatically for which purpose the tracking lever 17 can be acted on by a drive unit (not illustrated in FIG. 1). The drive unit 38, which will be described in more detail further below, serves for a pivoting movement of the tracking lever 17 clockwise with regard to FIGS. 1 to 9. The resulting opening process of the locking device 10 will likewise be described in more detail in the following figures.

Merely for the sake of completeness, it is pointed out at this juncture that that pawl section which is remote from the engagement projection 21 furthermore has a guide bolt 22 which, as shown in FIG. 1, bears against a guide surface 23 which is fixed with respect to a housing or the vehicle body, of for example a web-like guide 24. The guide 24 is in this case in particular formed so as to be divided into two parts, having a first, substantially straight starting section 25 and an adjoining, likewise substantially straight, subsequent second section 26 which however projects at an angle relative to the first section 25. A certain bend point 27 of the guide 24 is thus situated between the two sections 25, 26 of the guide 24.

For the sake of completeness, it is likewise mentioned that a pull-closed lever 28 which is mounted coaxially with the rotary catch 11, specifically is arranged by means of the pivot spindle 14 on the mounting plate 15, is also visible in FIG. 1. The pull-closed lever 28 is, in its starting position illustrated in FIG. 1, preloaded clockwise by means of elements not illustrated in any more detail, and can basically be pivoted counterclockwise with regard to FIGS. 1 to 9 by a drive mechanism (not illustrated) via a Bowden cable 29. In order that the pivoting process can (at a later point in time) lead to the rotary catch 11 being pulled closed, a pull-closed projection 30 is arranged articulatedly on the pull-closed lever 28 by means of a spindle 31. The pull-closed projection 30 is formed in the manner of a pawl and can, during the later pulling-closed of the rotary catch 11, engage a shoulder 37 (not yet illustrated in FIG. 1) formed on the rotary catch 11, as will be described in more detail further below.

A description has thus far been given of the basic construction of the locking device 10 according to the invention as per FIG. 1.

For the opening of the illustrated locking device 10, it would now fundamentally be theoretically possible for the pawl 12, as in the case of the described manual emergency opening, to merely be pivoted by means of a pivoting movement of the pawl 12 (counterclockwise about the spindle 16 with regard to the figures). This would however lead to the problem already described in the introduction, in which a pawl blocking surface, denoted by 32 in FIG. 1, of the pawl 12 would in this case pass out of engagement with the counterpart catch blocking surface, denoted by 33 in FIG. 1, of the rotary catch 11 very abruptly (and under the action of the full force of the seal element assigned to the door), which would lead to a certain disturbing generation of noise.

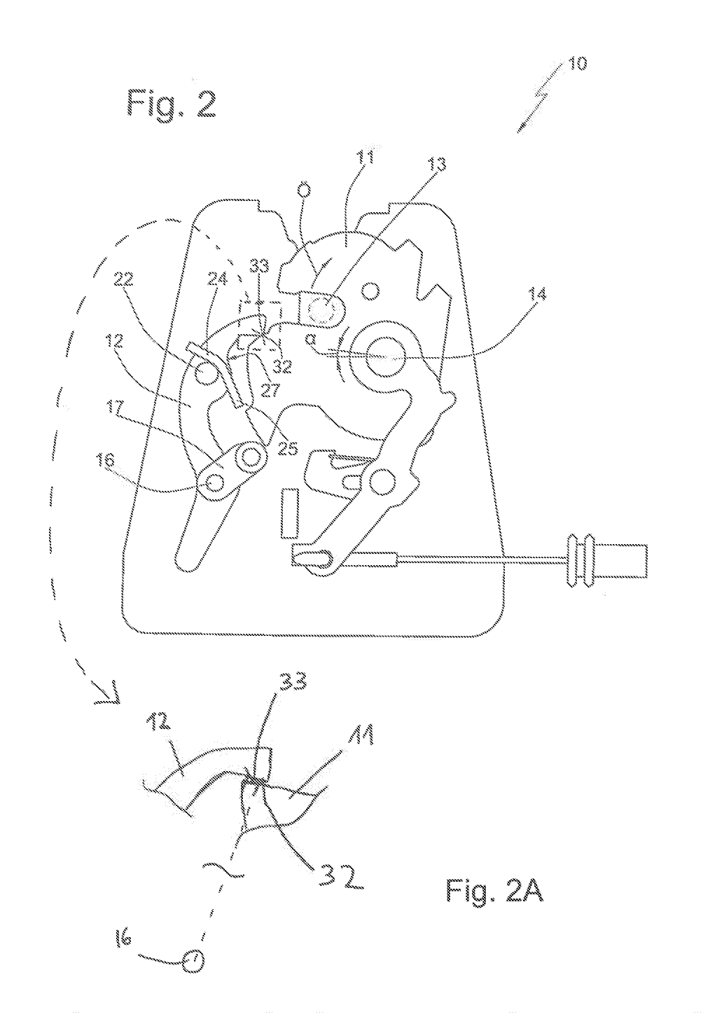

To prevent precisely this undesirable generation of noise, the pawl 12 is, according to the invention, moved in a different manner. For this purpose, proceeding from a position as per FIG. 1, the tracking lever 17 is pivoted about its pivot spindle 18 by a drive unit (which will be discussed in more detail further below) clockwise with regard to the plane of the figures. In this way, as illustrated by the transition from FIG. 1 to FIG. 2, a displacement of the pawl spindle 16 takes place as a pivoting movement clockwise with regard to the figures.

It also emerges from FIG. 2 (specifically in the enlarged illustration additionally shown at FIG. 2A) that the blocking surface 32 of the pawl 12 is arranged basically tangentially with respect to the pawl spindle 16. This permits a tracking movement according to the invention in a particularly simple manner. In the closed states of the locking device 10 illustrated in FIGS. 1 and 2, it is thus also the case that the counterpart blocking surface 33 (which makes contact with the pawl blocking surface 32) of the rotary catch 11 is oriented tangentially with respect to the pivot spindle 16 of the pawl 12. (This self-evidently changes as soon as the rotary catch 11 and pawl 12 pass out of engagement). The enlarged illustration in FIG. 2A of the tangentially oriented arrangement or orientation of blocking surface 32 and counterpart blocking surface 33 is self-evidently intended to apply to the other figures, in particular to FIG. 1, but for the sake of clarity has been illustrated on a large scale merely by way of example in FIG. 2A.

Since the pawl 12 is preloaded about its pivot spindle 16 toward the rotary catch 11, that is to say clockwise with regard to FIG. 2, the guide bolt 22 seeks to move along the guide 24. This occurs initially along the first section 25, until the bolt 22 reaches the bend point 27, which position is approximately illustrated in FIG. 2. In the position illustrated in FIG. 2, it is of particular note that, even though the rotary catch 11 has been rotated about its pivot spindle 14 in the opening direction Ö through a defined pivot angle α, the blocking surface 32 and the counterpart blocking surface 33 remain in engagement as shown in FIG. 2A. The rotary catch 11 is thus still blocked, and the closing element 13, indicated merely by dashed lines, still cannot emerge from the rotary catch 11, and is rather secured in the latter.

This securing action, despite an initial pivoting movement of the rotary catch 11 through an angle α, is made possible specifically by the tracking lever 17 which causes the blocking surface 32 to perform a tracking movement by means of a displacement of the entire pawl 12, and adapt the blocking surface 32 of the pawl 12 to the movement of the counterpart blocking surface 33 of the rotary catch 11.

FIG. 2 thus still illustrates a closed (but tracked) state of the locking device 10, in the case of which the contact region between blocking surface 32 and counterpart blocking surface 33 has been caused to perform a tracking movement, or has been raised (along with the maximum deflected position of the closing element 13 in the fork jaw), specifically by a defined travel. This tracking or raising travel is however preferably just smaller than an expansion travel “A” of a seal 34 assigned to the vehicle door, as illustrated in FIG. 12 (which will be described in more detail further below).

The advantage now consists in the fact that the seal 34, in a position corresponding to FIG. 2, is duly possibly not yet fully relaxed but is at any rate substantially relaxed or partially relaxed. The force exerted by the seal 34 on the door or flap (and thus on the closing element 13 and thus also on the rotary catch 11 and the counterpart blocking surface 32), and thus ultimately also on the blocking surface 33, is thus already considerably reduced.

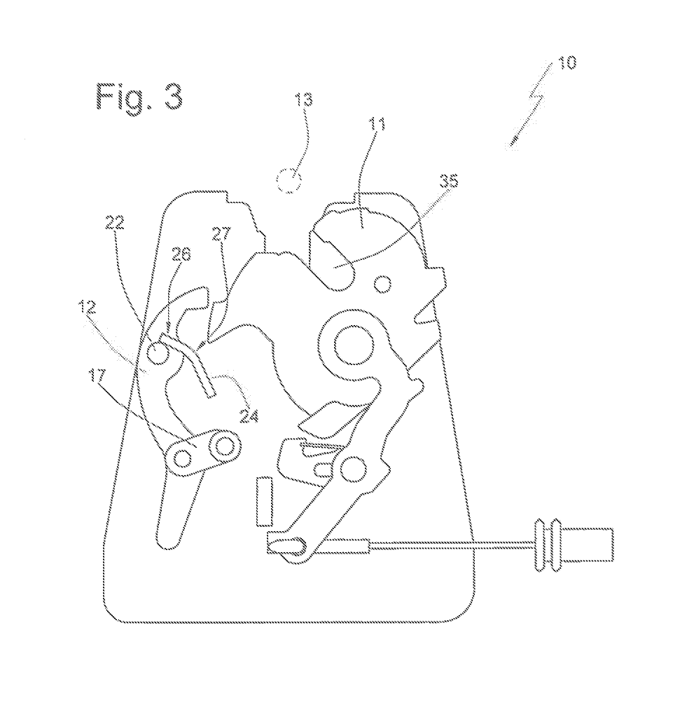

A subsequent disengagement of the pawl 12 and the rotary catch 11, as will now be described proceeding from FIG. 2, thus takes place under a considerably reduced action of force or frictional force on the surfaces 32 and 33. Proceeding from FIG. 2, the tracking lever 17 can be pivoted further in the opening direction (in particular in continuous fashion), that is to say clockwise in FIG. 3, by the stated drive unit 38 (which is however not shown), until the tracking lever 17 reaches the end position illustrated in FIG. 3. During such movement, owing to the contact of the guide bolt 22 with the guide 24, and in particular owing to the bend point 27 of the guide 24 and the differently oriented second section 26 of the guide 24 associated therewith, the pawl 12 is now no longer driven along by the rotary catch 11 (or by the counterpart blocking surface 33), but rather assumes a spacing relative to the rotary catch 11 and thus passes out of engagement therewith. Thus, as a result of the onward pivoting movement of the tracking lever 17—after the defined angle α of the rotary catch 11 is reached—the blocking surface 32 and the counterpart blocking surface 33 are moved out of engagement, and the rotary catch 11 is released.

FIG. 3 accordingly also shows the release position of the rotary catch 11 and the closing element 13 that has passed out of the jaw 35 of the rotary catch 11. The pawl 12 is illustrated in FIG. 3 in its deflected or release position, wherein the guide bolt 22 has reached the end of the guide 24 or of the section 26. With the opening process described immediately above, the problem of a certain generation of noise as in the prior art can be circumvented or at least greatly reduced.

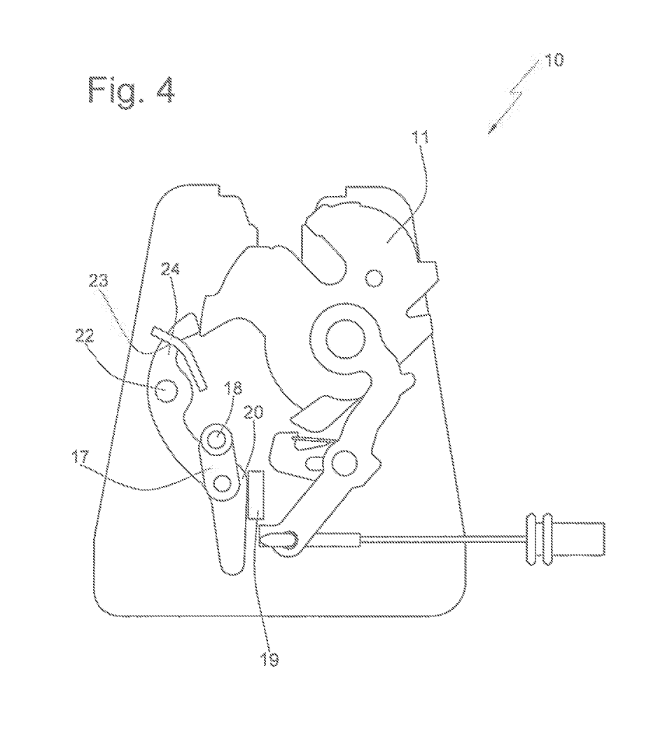

After the drive unit 38 acting on the tracking lever 17 has been active for a certain period of time (for example a time of between 100 and 1000 ms, for example 500 ms), the drive unit 38 can be shut down, and the tracking lever 17 can, as shown by the transition from FIGS. 3 to 4, pivot back about its spindle 18 into its initial position, that is to say counterclockwise with regard to the figures, until the knee 20 of the pawl 12 again reaches the stop 19. This is realized by a spring 41 (described in more detail further below), wherein, in FIG. 4, it can be seen that, during this return movement of the tracking lever 17 and the pawl 12, the guide bolt 22 assumes a spacing relative to the guide surface 23 of the guide 24. This spacing is also utilized by the locking device 10, as will be described further below in the context of the description of the anti-rattling system 42.

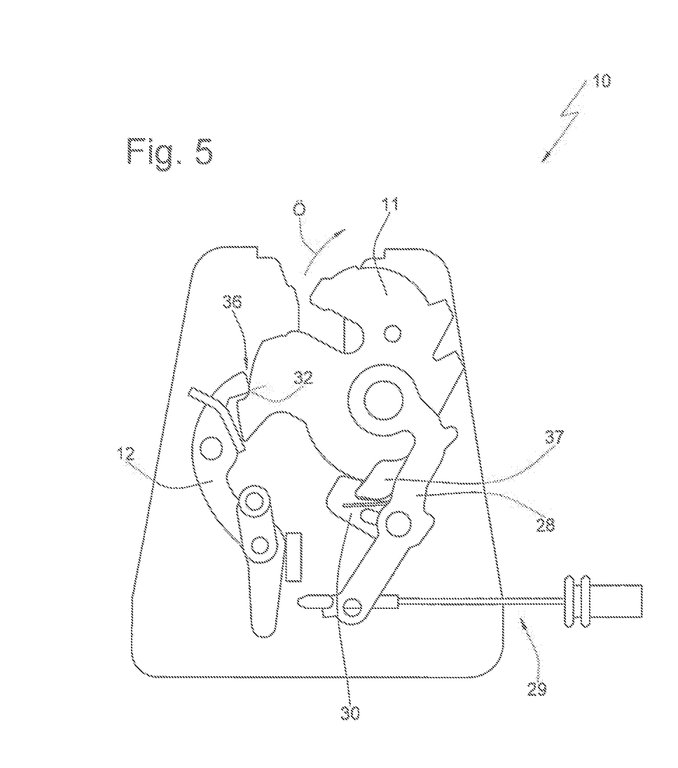

With regard to FIG. 4, it is finally pointed out that the rotary catch 11 is still situated in its open position. If a person, in particular the vehicle driver, wishes to close the vehicle door or vehicle flap again proceeding from a locked position as per FIG. 4, this is typically realized by means of a certain automatic exertion of force (pull-closed aid) on the rotary catch 11, which normally arises as a result of the flap coming to bear against the body. In this case, as the flap comes to bear, the rotary catch 11 pivots somewhat counter to the opening direction Ö as per the figure profiles of FIGS. 4 and 5, until the pawl 12 can engage with its blocking surface 32 into a pre-latching portion 36 of the rotary catch 11.

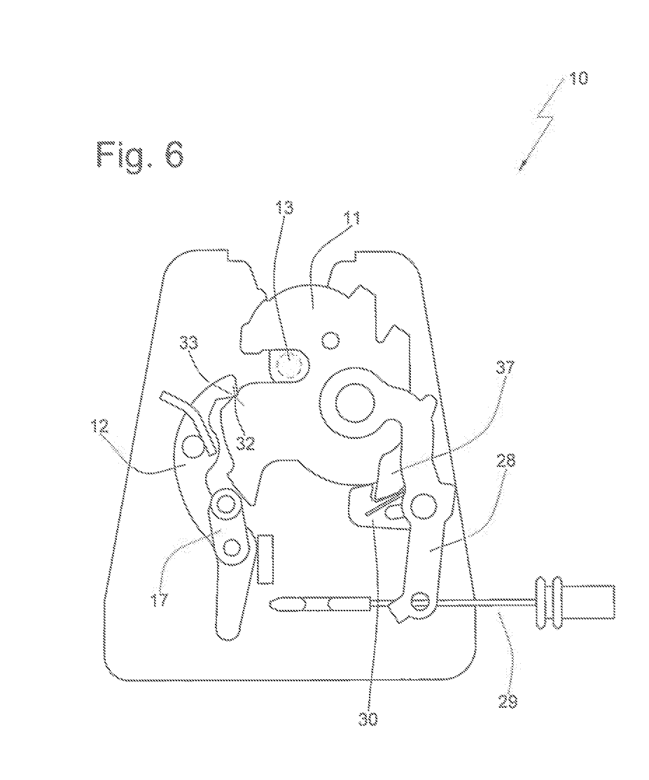

Proceeding from this pre-latching position as per FIG. 5, the rotary catch 11 can then be pulled back into its starting or closed position, for which purpose, as is likewise illustrated by the transition from FIGS. 4 to 5, the pull-closed projection 30 on the pull-closed lever 28 can engage behind a pull-closed projection 37 on the rotary catch 11. For this purpose, the locking device 10 may have sensor means (not illustrated) which (indirectly) detect the engagement of the rotary catch 11 into its pre-latching portion 36 and, in the event of corresponding detection, activate a drive mechanism (not illustrated) which acts on the Bowden cable 29. This activation of the drive mechanism thus leads, as illustrated by the transition from FIG. 4 via FIG. 5 to FIG. 6, to the rotary catch 11 being pulled closed into its fully closed position as per FIG. 6, which corresponds substantially to the position of the rotary catch 11 as per FIG. 1.

As described, for this purpose, the pull-closed projection 30 interacts with the pull-closed projection 37 on the rotary catch 11, wherein the pull-closed projection 30 engages behind the pull-closed projection 37. As per FIG. 6, it is then possible, when the closed position of the rotary catch 11 is reached, for the preloaded pawl 12 to fully engage, such that the blocking surface 32 again makes contact with the counterpart blocking surface 33, and the rotary catch 11 and the pawl 12 engage into one another.

As shown in FIG. 6, it is then possible, after deactivation of the drive which acts on the Bowden cable 29, for the pull-closed lever 28 to engage clockwise again with regard to FIG. 6, until the entire locking device 10 has thus reached its position or setting as per FIG. 1.

Description has thus far been given of the basic opening and closing process of the locking device 10.

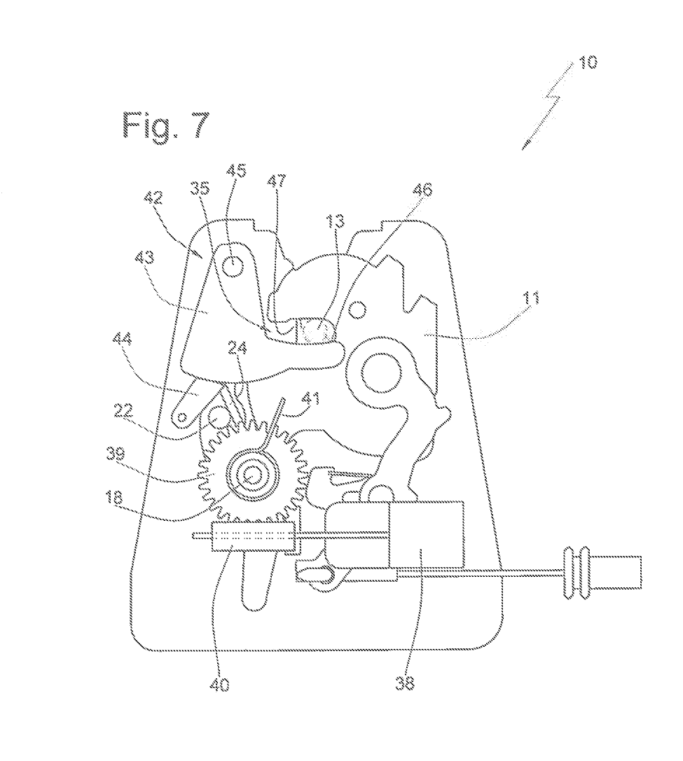

FIG. 7 shows the drive unit 38 which, by means of its activation, leads to the described displacement or pivoting of the tracking lever 17 (not illustrated in FIG. 7). The tracking lever 17 is specifically coupled (fixedly) in terms of motion, in particular in positively locking fashion, to a coaxially mounted worm wheel 39. For example, the worm wheel 39 may in this case be attached to the tracking lever 17 by means of an insert moulding process. The drive unit 38 acts on the worm wheel 39 via a worm 40 in a conventional manner, and can thus pivot the worm wheel 39 clockwise with regard to the figures for the purposes of opening the locking device 10.

In the exemplary embodiment illustrated, the drive unit 38 is in particular not of self-locking design, such that a later return movement of the tracking lever 17—that is to say counterclockwise with regard to the figures—can take place purely under the action of preload. For this purpose, it is for example the case that a spring 41 is mounted on the worm wheel 39 and with the free-standing end on the housing, which spring thus preloads the worm wheel 39 counterclockwise.

With regard to the plane of the drawing, the worm 40, the worm wheel 39 and the drive unit 38 are arranged in a different plane than, for example, the tracking lever 17, the pawl 12 and the rotary catch 11 or the pull-closed lever 28 or the pull-closed projection 30. It is advantageously thus provided overall, as illustrated in a supporting manner by FIG. 7, that one and the same drive, specifically the drive unit 38, serves both for a tracking movement within the meaning of the main claim and also for a transfer of the pawl into its open or release position, with a release of the rotary catch 11.

FIG. 7 also shows, in addition to the drive unit 38 itself of the locking device 10, a so-called anti-rattling system 42, which is composed substantially of a pressure lever 43 and a wedge lever 44. As can be seen from FIG. 7, the pressure lever 43 is in this case preloaded, about a pivot spindle 45 which is mounted on a vehicle body or mounting plate, in the direction of the closing element 13 and can, by means of a load-exerting flank 46, make direct contact with the closing element 13 and press or push the closing element 13 against a holding flank 47 of the jaw 35 of the rotary catch 11. By means of this action of force of the pressure lever 43, the closing element 13 can be prevented from bouncing back and forth in the jaw 35 of the rotary catch 11, for example when travelling on rough roads or the like.

However, in order that, in such a situation, the pressure lever 43 does not also deflect (and pivot clockwise with regard to FIG. 7), but rather continuously exerts load on the closing element 13, the wedge lever 44 is provided. Owing to specially designed contact contours on the pressure lever 43 and the wedge lever 44, the wedge lever 44 serves, in a manner known per se, to impart a stopping action. A similar action may self-evidently also be realized by means of a one-way latching means or the like rather than by means of specially designed wedge surfaces.

A special feature not illustrated in the figures consists in particular in that the wedge lever 44 can basically be pushed out of engagement by the guide bolt 22 of the pawl 12 (in particular clockwise with regard to FIG. 7). This means that, during a closing process of the locking device 10, that is to say in the case of a rotary catch 11 situated in an open position, the action or pressure lever 43 can be reset (clockwise with regard to FIG. 7) by means of a reinsertion, or pulling-closed movement, of the closing element 13. If the wedge lever 44, which is basically preloaded clockwise, were in the way here, this would not function.

However, since the guide bolt 22 is spaced apart from the guide 24 after an opening process of the rotary catch 11, the geometry of the device 10 can be selected such that the wedge lever 44 does not block, or does not counteract, a return of the pressure lever 43 during the closing process of the device. For this purpose, the bolt can engage behind a surface (not illustrated) on the wedge lever 44 and pull the latter away clockwise, counter to a preload.

In the case of a fully closed locking device 10, the guide bolt 22 is however then, as is also illustrated in FIG. 7, no longer situated spaced apart from the guide 24, and is thus also situated further to the right with regard to FIG. 7. In this situation, the wedge lever 44 can thus become active and engage counterclockwise to the extent necessary to ensure the functioning of the anti-rattling system 42.

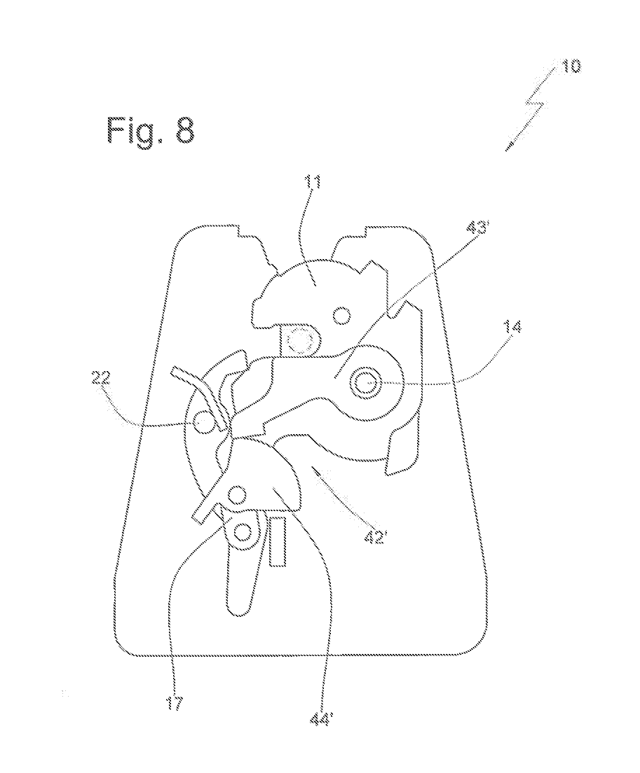

FIG. 8 shows a slight modification of the anti-rattling system 42, in the case of which the pressure lever 43′ is mounted coaxially with the rotary catch 11 on the spindle 14, and the wedge lever 44′ is mounted coaxial with the tracking lever 17. The modified anti-rattle system 42′ otherwise functions similarly, where in here, however, the guide bolt 22 indeed does not cooperate with the wedge lever 44′, the latter rather being capable of being disengaged in some other way.

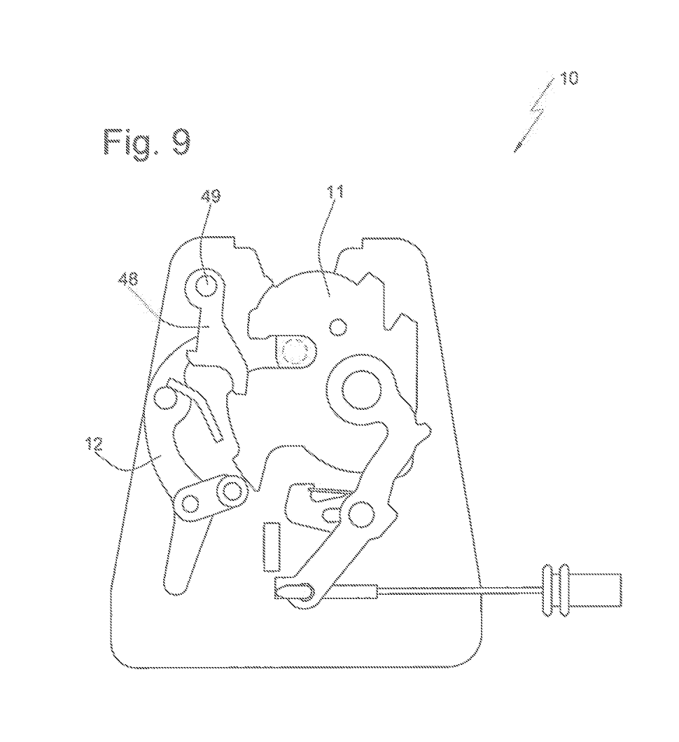

FIG. 9 shows the locking device 10 with an optionally installed snow-load lever 48 which is mounted so as to be pivotable about a spindle 49. The snow-load lever 48 is basically known from other locks and has the function of preventing an engagement of the pawl 12 in a situation in which a certain weight (caused for example by a snow load) is situated on the flap, bonnet or door and the rotary catch 11 does not at all automatically pivot in the opening direction Ö (the rotary catch 11 thus remains in its closed position). In this case, the pawl 12 should not engage. This is prevented in a known manner by the snow-load lever 48.

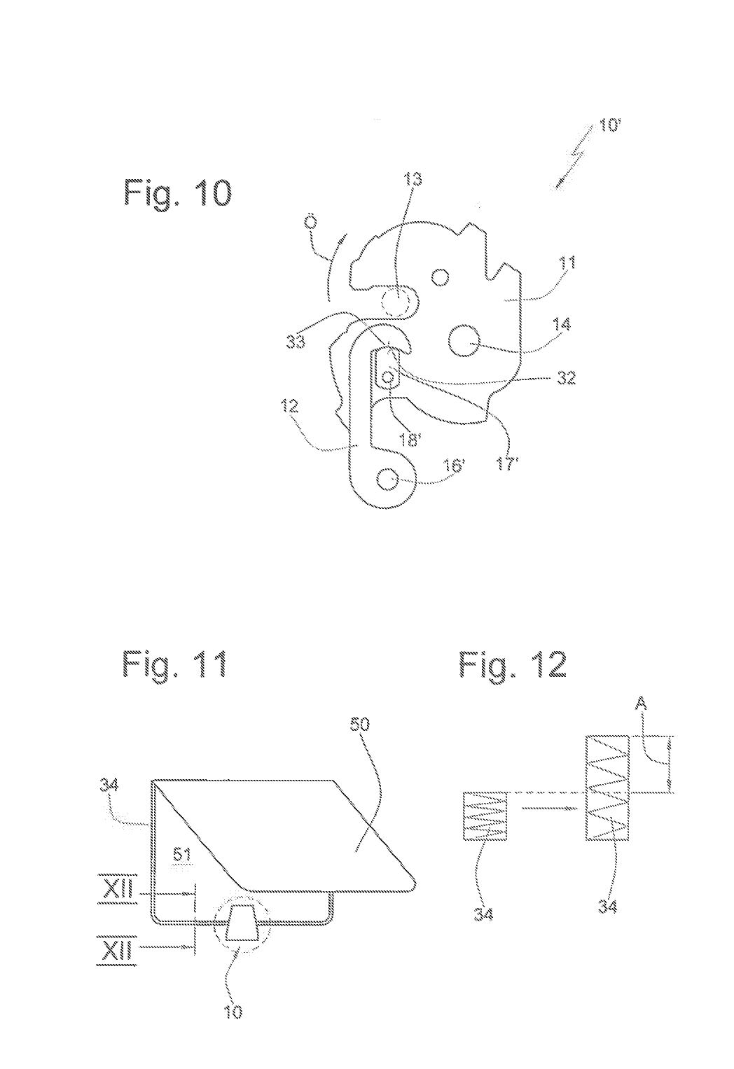

FIG. 10 shows an alternative exemplary embodiment of a locking device 10′ according to the invention in a highly schematic illustration, for example also with a mounting plate or the like being omitted. The primary difference consists in this case in that the tracking lever 17′ is arranged, by means of its pivot spindle 18′, not on the vehicle body or on a mounting plate but rather on the rotary catch 11 itself. By contrast to the preceding exemplary embodiment, the spindle 16′ of the pawl 12 (which may theoretically be of similar appearance as in the preceding exemplary embodiment, but is illustrated in simple form in FIG. 10 for the sake of simplicity) is not displaceable or adjustable.

In the context of the present application, it is also possible in this exemplary embodiment for the tracking lever 17′ to be regarded as part of the rotary catch 11. At any rate, the tracking lever 17′ provides the counterpart blocking surface 33 which, in the illustrated closed position, is in engagement with the blocking surface 32 on the pawl 12. For the opening of the illustrated locking device 10′, it is for example possible for a drive unit (not illustrated) to displace the tracking lever 17′ in this case counterclockwise (with regard to FIG. 10 into a position which is not illustrated) in the above-described manner, specifically such that the rotary catch 11 can pivot through a certain defined angle α in the opening direction Ö, wherein the blocking surface 32 on the pawl 12 and the counterpart blocking surface 33 on the tracking lever 17′ or on the rotary catch 11 remain in engagement. Typically, the pawl 12 will in this case be pivoted somewhat counterclockwise with regard to FIG. 7. By means of a further pivoting of the tracking lever 17′, the blocking surfaces 32 and 33 can then pass entirely out of engagement, whereby the rotary catch 11 and the pawl 12 also pass out of engagement, and the rotary catch 11 can pivot to its open position.

No further explanations relating to the exemplary embodiment as per FIG. 10 are necessary, because it is merely a schematic diagrammatic illustration. It is however possible for all of the considerations described with regard to FIGS. 1 to 9 to be transferred to said exemplary embodiment, at any rate where technically compatible.

With both exemplary embodiments, it is thus possible to solve the problem of the prior art whereby a banging noise or a generation of noise occurs during the opening of a door or tailgate flap 50 schematically indicated in FIG. 11, because the door or tailgate flap generally, in its closed position which is not illustrated, compresses a typically encircling seal 34 which surrounds the opening 51 of the vehicle (as is also schematically indicated in the left-hand illustration in FIG. 12). When the flap 50 is in the open position as per FIG. 11, the seal 34 is, by contrast, typically fully relaxed, as illustrated by the right-hand image of the seal 34 in FIG. 12. The difference between the fully compressed position and the fully relaxed position of the seal 34 is denoted in FIG. 12 by the travel “A”, and in practice typically amounts to between 5 and 10 mm, for example between 6 and 8 mm, in particular approximately 7 mm.

The distance by which the contact region between blocking surface 32 and counterpart blocking surface 33 is typically caused to perform a tracking movement (and by which also the closing element 13 can be raised while the rotary catch is still closed) thus typically amounts to slightly less, for example between 1 and 6 mm, preferably approximately 5 to 6 mm.

Finally, it is pointed out that the arrangement of the device 10 in FIG. 11 is rather atypical and contrary to the preceding description, because said device is arranged on the vehicle body there. An arrangement on the flap is however more typical.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A locking device for a vehicle door, comprising:
a rotary catch which can be arrested by a pawl and which serves for trapping a closing element when the vehicle door is closed, the pawl having a blocking surface and the rotary catch having a counterpart blocking surface which can be placed in engagement with the blocking surface; and
a tracking lever associated with one of the pawl and the rotary catch and being operable such that the blocking surface or the counterpart blocking surface can be caused to perform a tracking movement relative to the other of the blocking surface or the counterpart blocking surface when the rotary catch is pivoted over a defined pivot angle (α) in an opening direction (Ö) without the blocking surface and the counterpart blocking surface moving out of engagement.

2. The locking device according to claim 1, wherein a spindle of the pawl is displaced by the tracking lever, and wherein the spindle of the pawl is arranged on the tracking lever.

3. The locking device according to claim 2, further comprising an unilateral guide on which the pawl is preferably supported during an opening process, but from which the pawl is spaced apart further during a closing process.

4. The locking device according to claim 3, wherein the guide includes first and second sections divided by a bend point.

5. The locking device according to claim 1, wherein the pawl can be transferred into its release position by the tracking lever.

6. The locking device according to claim 1, wherein the vehicle door has a seal element which is compressed when the vehicle door is in a closed position and which fully relaxes over an expansion travel distance (A) when the vehicle door moves into an open position.

7. The locking device according to claim 6, wherein the tracking travel distance over which the tracking lever causes the blocking surface or counterpart blocking surface to perform the tracking movement is smaller than the expansion travel distance (A), or wherein the seal element is not fully relaxed when the rotary catch reaches the defined pivot angle (α).

8. The locking device according to claim 1, wherein the pawl and/or the tracking lever are spring-preloaded into their initial position.

9. The locking device according to claim 1, wherein the pawl and/or the tracking lever interact with an anti-rattling system for acting on the closing element in such a way that a return movement of the pawl and/or the tracking lever into their respective initial position leads to the reversal of at least a part of the anti-rattling system.

10. The locking device according to claim 2, wherein the spindle of the pawl is arranged so as to be displaceable relative to a spindle of the rotary catch.

11. A method for utilizing a locking device of a vehicle door, comprising the steps of:
providing a rotary catch which can be arrested by a pawl and which serves for trapping a closing element when the vehicle door is closed, wherein the pawl has a blocking surface and the rotary catch has a counterpart blocking surface which can be placed in engagement with the blocking surface;
activating a tracking lever assigned to one of the pawl and the rotary catch; and
causing the blocking surface or the counterpart blocking surface to perform a tracking movement such that the rotary catch pivots over a defined pivot angle (α) in an opening direction without the blocking surface and the counterpart blocking surface moving out of engagement.
